(19) United States
(12) Patent Application Publication
(10) Pub. No.: US 2012/0059731 A1
(43) Pub. Date: Mar. 8, 2012

(54) Method to Facilitate Electronic Commerce Between Buyers and Sellers Using a Buyer-Initiated System

(76) Inventor: Jason Silver, Ellicott City, MD (US)

(21) Appl. No.: 12/877,082

(22) Filed: Sep. 7, 2010

(51) Int. Cl. G06Q 30/00

(52) U.S. Cl. 705/26.2

(57) ABSTRACT

This invention is a method of brokering a relationship between buyers and sellers via electronic means by way of an intermediary facilitating this relationship. Potential buyers of goods or services relay their requirements and desired range of pricing for a good or service to an aggregator. A potential buyer's personal contact information is hidden from any seller that would be interested in selling a buyer the requested good or service. Sellers have the option of searching a list of willing buyers of goods or services or may have this list sent to them electronically. Additionally, the requirements of buyers may be proactively used to search seller websites or databases via a web crawler. A brokerage fee to an aggregator is all that is required for a seller to gain access to a buyer via proxy. This method does not bind buyers to sellers. It allows a buyer to set a pre-determined price range based on his requirements for a good or service and a seller to make an initial connection with a buyer based on these needs. Should a buyer transact with seller, the buyer is incentivized to report the sale to the intermediary such that an additional transaction fee may be charged by the aggregator.

### BACKGROUND

Auction web sites are ubiquitous on the Internet. Most sites such as Ebay and Yahoo! Auctions facilitate buyer-seller transactions in which sellers attempt to attract buyers. These sites have become quite popular as the Internet has become a medium in which goods and services could be made available to a large scale of people.

There are fewer web sites in which the buyer is the driver of the sale. An example of this is Priceline (U.S. Pat. No. 5,794,207). Priceline allows a buyer to “name his own price” in which the buyer is obligated to purchase a product via a binding agreement with a willing seller. Complete information about the buyer is made available at the time of purchase, and the buyer cannot withdraw upon submission of a bid. Priceline requires payment a guarantee of payment upfront to go between buyer and seller via Priceline as an intermediary. It also requires the buyer to pay a service fee for the use of Priceline's services.

While there are services that offer anonymous connections to buyers and sellers, none require buyer feedback as to whether a transaction commenced. This novel approach allows a business model to be created which keeps initial fees low thus facilitating use of the system.

### SUMMARY OF INVENTION

In the preferred embodiment, a prospective buyer of a good or service would register with an aggregator. This registration would consist of at least one of: a prospective buyer's name, address or location information, telephone number, and e-mail address. A seller who wishes to purchase contact information of a potential buyer via the aggregator for the purpose of making a sale to that buyer, would register his personal/business information to include name, address, telephone number, e-mail address, payment information and a description of their business and or offerings. A seller would additionally enter his credit card number or checking account number into the site so as to be charged when a buyer of interest is matched. A seller would also have an option of allowing a percentage of the aggregator's fee to be donated to a pre-defined charity. A match between a buyer and seller may occur by a seller actively searching the website for a buyer either 1) directly 2) by a continuous automated search based on seller inputted data to the aggregator 3) by a continuous search of a registered seller's databases by the aggregator of goods or services offered by potential sellers. Additionally, the aggregator could proactively search non-registered seller's websites and/or databases looking to match a buyer's inputted request. If a match is found, the aggregator would alert the seller by electronic means that a buyer may be interested in purchasing a seller's good and/or service. The seller would then decide whether they would want to purchase the contact information of the buyer from the aggregator for the purpose of potentially making a transaction.

During this registration process the user, if acting as a buyer, would specify what information he would want disclosed if a seller were to make contact with him. Although a buyer may elect to release his telephone number directly to a buyer, the potential buyer of a good or service may chose to have the aggregator serve as a proxy between the buyer and a seller. As such, the buyer does not have to reveal his complete identity until he decides to make a purchase from a seller.

Users would have login accounts which would consist of a login name and password. Upon login, or anytime during his session, a user would decide whether he would act as a buyer or a seller.

If acting as a potential buyer of a good or service, the user would select one of the available categories of goods or services that best fits his needs. If a category does not exist, the user would have the ability to suggest a new category to be added. He would then select options from a pre-defined list that his ideal good or service would have. He would then type in additional user comments to be more specific about what he wants to buy. Finally he would enter the maximum price he is willing to pay along with the amount of time he would like his ad to be posted (the maximum time being the default).

When a seller (or user that has not specifically indicated that he is a buyer) enters the community, he will see varied categories of goods and services to choose in which willing buyers can be found. He will also have access to a search function to quickly narrow his search. A seller may also sign up for a service allowing the aggregator to send alerts to him as soon as a new buyer enters a new posting. Alerts may be sent to potential sellers which the aggregator proactively finds via a web crawler or another search feature. These alerts could be sent to either registered or unregistered sellers.

When a seller proactively finds a buyer of a good or service of which he believes he can provide, the seller can then select the posting from that buyer. The seller would then either register or log-in to the community so that his identity is known. The seller would then be told of the cost to attain the buyer's information. There would never be any contact between the buyer and seller before payment is made to the aggregator. Once this payment is made, correspondence will be facilitated by the aggregator between a buyer and seller.

The following example shows a possible flow of this method for a buyer wanting to purchase a 1999 or 2000 Volvo C70 Coupe for $15,000. A buyer would:

1) Sign in with the aggregator. If he is not a member, he would enter registration information and including a preferred method of contact along with a login name and password

2) Chooses to select Automobiles, then Volvo, then C70 Coupe

3) Chooses year(s) of interest, then selects desired options from a predefined list such as “Power Windows”, “Power Locks”, “Mileage Less Then 50,000”, “High Pressure Turbo”, “Color—Blue”, and “Leather Interior”, He then chooses if he would like his ad posted for a “domestic” audience of sellers or an “international” audience of sellers

4) Selects how long he would like the ad posted with the maximum posting time set as the default

5) He then types in the text box, “must have all service records” as this may not be a selection

6) He then types-in the maximum price (or approximate price) he is willing to pay

7) He submits this information to the data aggregator

A seller who visits the aggregator's website and has a 1999 or 2000 Volvo for sale is taken through the following flow:

1) A potential seller may have been alerted to this new posting by the aggregator if he is registered with the aggregator and had chosen to be alerted if this make and/or model is wanted by a buyer. Additionally, a potential seller may be alerted proactively by the aggregator. This potential seller may or may not be a registered user of the aggregator's website. A seller may also have come across this by browsing these “wanted” items without a previous alert.

2) If the seller is already registered (or placed on the “registered” list) and immediately alerted, an identifier routing the seller directly to the ad would be sent with the alert so that the seller can instantly view the ad for the 1999 or 2000 Volvo C70 Coupe. If not alerted, the seller could scroll through categories such as, “Automobiles, then Volvo, then C70 Coupe” or merely does a text search for “Volvo” and/or “C70 Coupe”.

3) Upon reading the ad for the Volvo, the seller decides if he would like to determine the contact information of the buyer. If so, he would select the ad and enter his payment information to the aggregator. Upon acceptance by the aggregator, the aggregator would then serve as a proxy to connect a buyer to a seller.

Additionally, the aggregator can proactively seek out—both registered and unregistered—sellers of a good or service requested by a buyer. If a match is found by the aggregator, a seller would be alerted to visit the aggregator's website so that the aggregator can facilitate a potential transaction.

I claim:

1. A method for using a computer or device with access to computational ability to facilitate a transaction between at least one buyer and a potential seller, comprising the steps of:
(a) inputting into the said device contact information of a perspective buyer;
(b) inputting into the said device a conditional purchase offer with specifics to the good or service to include an offer price or price range;
(c) outputting the conditional purchase offer and information regarding previous transactions made by a particular buyer to a seller or a plurality of sellers;
(d) connecting buyer to seller via an electronic platform upon payment of a service fee to a data aggregator by an interested seller;
(e) soliciting feedback from a buyer whether a transaction occurred

2. The method of claim 1, in which inputting into the said device contact information of a perspective buyer comprises:
inputting into the said device buyer name, buyer address or physical location, buyer e-mail address, and buyer telephone number, so as the information aggregator may store such information in a database

3. The method of claim 2, in which buyer contact information is aggregated into a data storage facility:
The storage facility is to be connected to the data aggregator's computer for the purpose of storing and retrieving this data as necessary for operations

4. The method of claim 2, in which a buyer wishes to be contacted to include at least one of buyer name, buyer address or locational information, buyer e-mail address, and buyer telephone number are inputted:
The buyer and seller are united via proxy. At the initial connection, the seller only knows of an interested buyer; his identity is not revealed. At a buyer's choosing, subsequent communication may continue via proxy or by direct communication between buyer and seller

5. The method of claim 1, in which a conditional offer which includes an offer price further comprises:
a selection of pre-determined attributes associated with said good or service to be purchased.

6. The method of claim 5 further comprises:
The ability to convert pre-determined attributes into one or more languages whereby international reach can be attained

7. The method of claim 5, further comprises:
a means in which a buyer may input additional attributes desired of the good or service to be purchased

8. The method of claim 7, further comprises:
The ability to convert buyer determined write-in attributes into one or more languages whereby international reach can be attained

9. The method of claim 7, further comprise:
A database connected to the aggregator's computer which said pre-selected and user-determined attributes are stored

10. The method of claim 1, in which outputting the conditional purchase offer to the plurality of sellers occurs comprises:
Buyer city, state (if applicable), and country of residence are included along with conditional purchase offer and is posted

11. The method of claim 1, in which the payment to the information aggregator is performed:
The information aggregator may elect to award incentives to buyers and/or sellers who ultimately complete a purchase

12. The method of claim 1, in which conditional offers are outputted to the plurality of sellers:
Sellers can search the conditional offers via the said device or have seller pre-selected information of the said good or service forwarded to them.

13. The method of claim 1, in which an acceptance to purchase buyer contact information for the aggregator:
The aggregator and seller agree on a payment method

14. The method of claim 1, in which an acceptance to purchase buyer contact information for the aggregator:
The seller of the good or service purchasing the buyer contact information understands that a buyer is not obligated to purchase a good or service from a seller

15. The method of claim 1, further comprises:
The ability for a seller to select one or multiple buyers of which to purchase contact information from the information aggregator

16. The method of claim 1, in which buyer information is released to a seller, further comprises:
a non-binding agreement between buyer of said good or service and seller of said good or service

17. The method of claim 1, further comprises:
a searchable list of buyers

18. The method of claim 1, further comprises:
a predetermined timeframe of which said buyer can post his offer

19. The method of claim 1, further comprises:
a variable pricing model allowing sellers to pay variable amounts for a buyer's contact information depending on the type of good or service requested and the amount of time a buyer's ad is posted

20. The method of claim 1, further comprises:
a seller commits that he will not sell his good or service for a price above the buyer's stated upper limit unless new requirements are subsequently added by the buyer or the buyer allows higher offers to be entertained

21. The method of claim 1, further comprises:
a buyer being incentivized via a financial or other reward for reporting that a transaction has occurred

22. The method of claim 1, further comprises:
a transaction fee to the aggregator being paid by a seller

23. The method of claim 1, further comprises:
a seller will be given information based on buyer activity when available

24. The method of claim 1, further comprises:
the number and type of transaction reported by a buyer is stored upon a purchase

25. The method of claim 1, further comprises:
the ability for a buyer of information to select a charity which a percentage of the transaction may go

26. The method of claim 1, further comprises:
the ability to ‘crawl’ websites and/or databases of potential sellers so as to proactively match these sellers with potential buyers. Sellers would be alerted that there is a potential buyer of their product and will thus be advised that they can purchase information connecting them to a potential buyer

27. The method of claim 1, further comprises:
the ability of a seller to input his goods or services directly into the aggregator's website, thus allowing prompt notification to the seller if a potential buyer enters a request for a good or service that a seller can satisfy

28. The method of claim 1, further comprises:
incentivizing a buyer to report a successful transaction to the aggregator such that a seller could be charged an additional fee to the aggregator for a successful transaction

29. The method of claim 1, further comprises:
the ability to send alerts to potential buyers that a seller has a good or service of interest to them

30. The method of claim 1, further comprises:
the ability to send alerts to sellers, whether registered or unregistered, that a potential buyer is interested in their good or service

31. The method of claim 1, further comprises:
the ability of a buyer to choose a geographic region of which he is willing to purchase a good or service from

32. The method of claim 1, further comprises:
the ability for a seller to contact a buyer via the aggregator even if every requirement requested by a buyer cannot be met by a seller
